(19) United States
(12) Patent Application Publication
(10) Pub. No.: US 2017/0023386 A1
(43) Pub. Date: Jan. 26, 2017

(54) PROBE HOLDER FOR A MEASURING INSTRUMENT

(71) Applicant: Testo AG, Lenzkirch (DE)

(72) Inventors: Jorg Binder, Friedenweiler (DE); Holger Frank, Gilching (DE)

(73) Assignee: Testo AG, Lenzkirch (DE)

(21) Appl. No.: 15/095,544

(22) Filed: Apr. 11, 2016

(30) Foreign Application Priority Data
Apr. 11, 2015 (DE) 102015005265.9

(51) Int. Cl. G01D 11/30; G01D 11/24

(52) U.S. Cl. CPC G01D 11/30; G01D 11/245

(57) ABSTRACT

A probe holder having an access element which can be fitted to an opening in a wall of a pipe is provided. The access element has at least a portion of a continuous access opening, which is constructed for inserting a rod-like measuring instrument into the opening, and having a retention element which is constructed to secure the probe holder to the wall of the pipe. An arresting element is arranged to be movable relative to the access element in an insertion direction of the access opening between a first position and a second position, wherein the arresting element cooperates with the retention element in such a manner that in the first position a state which fixes the securing is defined and in the second position a state which releases the securing is defined.

### INCORPORATION BY REFERENCE

The following documents are incorporated herein by reference as if fully set forth: German Patent Application No. 102015005265.9, filed Apr. 11, 2015.

### BACKGROUND

The invention relates to a probe holder having an access element which can be fitted to an opening in a wall, in particular of a pipe, wherein the access element has at least a portion of a continuous access opening which is constructed for inserting an in particular rod-like measuring instrument into the opening, and having a retention element which is constructed to secure the probe holder to the wall of a pipe.

Probe holders are conventionally used to be able to secure in particular rod-like measuring instruments (probes) to a wall of a pipe, wherein by using the measuring instrument which is retained by the probe holder and which is secured to the pipe, a measurement value of a fluid flowing through the pipe, in particular a gas or a liquid, is established. Such probe holders are conventionally inserted by a retention element which is formed on the access element directly into the opening in a wall of a pipe and conventionally secured purely by friction forces between the access element or the retention element and a friction face on the pipe opening on the pipe. A disadvantage of existing probe holders is therefore, for example, that the removal and fitting of the previously known probe holder are very complex to manage, for example, as a result of the fact that the probe holder has to be screwed and secured to the pipe in particular by additional retention devices. In need of further improvement is the configuration of the fixing stability of the probe holder to a wall of a pipe since, in previous embodiments, this is often only very inadequate.

### SUMMARY

An object is therefore to provide a probe holder of the type mentioned in the introduction which overcomes the disadvantages mentioned above of existing probe holders.

The object of this invention can be achieved by one or more features of the invention as described below and in the claims. In particular, it is consequently proposed according to the invention with the probe holder described in the introduction in order to achieve the objective that an arresting element be arranged so as to be able to be moved relative to the access element between a first position and a second position, wherein the arresting element cooperates with the retention element in such a manner that in the first position a state which fixes the securing is defined, and in the second position a state which releases the securing is defined. In the position for use of the probe holder in a wall of a pipe, there is therefore provision for the arresting element to be in the first position so that the probe holder according to the invention is fixedly secured to the wall. In order to remove the probe holder from the wall, there is provision for the arresting element to be moved into the second position so that the fixing of the securing is released.

This allows the probe holder according to the invention to be able to be fitted directly to an opening of a wall, in particular of a pipe, by the access element and the construction of the probe holder according to the invention, as a result of a displacement of the arresting element relative to the access element, allows the probe holder according to the invention to be able to be secured to the wall or the opening in a simple and very stable manner.

Furthermore, there may be provision for the probe holder, in particular the access element, to form at least a portion of an access channel for receiving an in particular rod-like measuring instrument. An access channel may in this instance act as a guide for inserting the in particular rod-like measuring instrument in the insertion direction in the access opening, in particular in order to prevent incorrect handling when inserting the measuring instrument and/or to predetermine the correct orientation of the measuring instrument. A particularly advantageous construction of the probe holder according to the invention may make provision for the arresting element to be arranged outside an or the above-mentioned access channel. Consequently, the arresting element is also readily accessible for actuation when the probe is inserted from the outer side, for example, by a handle.

In an embodiment of the invention, there may be provision for the arresting element to be arranged so as to be able to be moved relative to the access element in an insertion direction of the access opening between the first position and the second position. Consequently, a space-saving actuation can be carried out in particular in or on an access channel which defines the access opening.

It is advantageous for the access element to be constructed for fitting to an opening in a wall of a pipe. Consequently, an examination of a substance or sample which is located or which flows in the pipe can be carried out in a simple manner with a probe which is inserted in the probe holder.

In an embodiment of the invention, there may be provision for a clamping movement to be able to be carried out with the retention element. Consequently, secure retention on the opening can be produced without specific preparations being required on this opening. It is particularly advantageous in this case if the clamping movement brings about an expansion or a narrowing. Consequently, a formation of the opening can be used, for example, as a connection piece for the clamping holder. Alternatively or additionally, in this instance the clamping movement may be achievable by the movement of the arresting element.

It is advantageous in this instance for the clamping movement to be able to be carried out in a simple manner with the adjustment of the arresting element.

In order to be able to move the arresting element relative to the access element by simple and comfortable handling, it may be advantageous for the probe holder according to the invention to have an actuatable handle, for example, the handle which has already been mentioned. In particular there may be provision for it to have an actuation lever which can preferably be actuated laterally with respect to the insertion direction, in particular with respect to the extent direction of an or the access channel. An advantage of this embodiment is, for example, that the probe holder can be secured with only one hand to a wall of a pipe. Preferably, the actuation lever is acted on by a restoring element which can retain the arresting element in a fixing position. Another embodiment of the handle may be constructed in such a manner that the handle is constructed as an actuation screw which is rotatably arranged in particular about the longitudinal axis of the insertion direction, preferably about the longitudinal axis of an or the access channel. It may be advantageous for the handle of the probe holder according to the invention to be constructed for in particular stepless movement of the arresting element from the first position into the second position. There may further be provision for the arresting element to be able to be moved counter to a restoring force of a restoring element from the first position into the second position, in particular in a stepless manner. Another advantage is in particular that the action of force which acts on the wall, in particular as a result of the retention element and/or the arresting element, in particular as a result of one or more standing bases, can be adjusted in particular in a stepless manner by the handle. It can thereby be determined how strong the fixing of the securing is intended to be.

In order to be able to further increase the stability of the securing, there may be provision for the retention element to be constructed for introduction into an or the opening which has already been mentioned above, in particular for engaging behind an or the opening which has already been mentioned above. It may be particularly advantageous for the retention element to have a hook which is arranged in particular in an extension of a longitudinal axis of the insertion direction, in particular in an extension of a longitudinal axis of a supply channel. For example, the retention element may be constructed integrally on the access element, which is simple to produce.

Alternatively to the above-mentioned construction of the retention element of the probe holder according to the invention, in order to solve the problem according to the invention, there may be provided another embodiment of the retention device in which the retention element is constructed for preferably securing the probe holder to a pipe nozzle at the outer side. In particular it may be constructed in such a manner that the retention element is constructed so as to be able to be pressed in a radial direction with respect to the longitudinal axis of the insertion direction against a wall of a pipe. In this instance, there may be provision for the retention element to act on a face which is constructed in an oblique manner, preferably a face constructed in an oblique manner on the inner side of a housing, and relative to which it is movably arranged, in particular together with the arresting element. Preferably, the retention element is connected to the arresting element in an articulated manner, in particular in such a manner that the retention element is movably arranged about a pivot location. It may further be preferable for the retention element during a relative movement, in particular together with the arresting element, to be redirected by the oblique face in the direction toward the oblique face in the direction of the wall of a pipe and/or for it to define in the first position a smaller inner diameter with respect to the longitudinal axis of the insertion direction than in the second position.

It may be advantageous for the probe holder according to the invention to have a plurality of retention elements which are in particular constructed differently. For example, an embodiment according to the invention is conceivable which comprises the two above-described embodiments on retention elements. This has the advantage that, using such an embodiment of the probe holder according to the invention, securing to differently constructed openings in a wall of a pipe is possible, for example, to an opening in a side wall of a pipe and to an opening of a wall of a pipe nozzle.

There may further be provision for the arresting element and/or a housing, for example, the above-mentioned housing, to have at least one standing base, in particular at least two, preferably three, standing bases which is/are arranged so as to be laterally offset with respect to the access opening, in order to be able to support the probe holder according to the invention on a or the wall of a pipe. A particularly well-balanced support in which the forces are distributed in a very uniform manner on the individual standing bases can be achieved when the arresting element has at least two standing bases, in particular at least three standing bases.

A simple and at the same time robust construction of the probe holder according to the invention may make provision for the arresting element to be movably arranged relative to the access element by means of a thread and a corresponding counter-thread. It may further be preferable for the retention element and the arresting element to define between them an in particular variable spacing. In this instance, it may be advantageous for the spacing between the retention element and the arresting element in the second position of the arresting element to be wider or at least as wide as the thickness of the wall of one pipe and/or for the spacing between the retention element and the arresting element in the first position of the arresting element to be smaller than or equal to the thickness of the wall of one pipe. This is particularly advantageous with securing to a thin wall of a pipe.

There may be provision for the access element and the retention element to be connected to each other. The access element and the retention element may also be constructed integrally. In order, for example, to be able to replace the retention element, it may be advantageous for the retention element to be constructed so as to be able to be removed from the access element. This has the advantage that different retention elements can be used with a probe holder.

In order to be able to fix the in particular rod-like measuring instrument by the probe holder according to the invention, in particular inside a supply channel, for example, the supply channel already mentioned above, there may be provision for the probe holder according to the invention to have a clamping element for axially fixing an in particular rod-like measuring instrument which is inserted into the access opening. In particular, there may be provision for the clamping element to be configured at a proximal end of the supply opening, in particular at a proximal end of a supply channel, for example, the supply channel already mentioned above.

In order to seal a gap, for example, between the opening and the access element, it may be advantageous for the probe holder according to the invention to have a sealing element. There may be provision for this to be an annular sealing element. In order to provide the most space-saving and compact possible construction of the probe holder according to the invention, which enables good sealing, it may be advantageous for the sealing element to be arranged on the access opening and/or at the outer side of the access element. Furthermore, there may be provision for the sealing element to be arranged at the outer side of an or the access channel. It may further be preferable for the sealing element to be produced from a resilient material, preferably from an elastomer material, for example, from rubber. It may be constructed as a sleeve and/or as a sealing lip, in particular in a conical and/or truncated cylindrical form. This enables relatively good sealing of the gap so that no fluid can escape and/or non-distorted measurements can be carried out using the measuring instrument.

A particularly advantageous construction of the probe holder according to the invention may provide for the probe holder to be configured in such a manner that, as a result of the relative movement of the arresting element in the direction toward the access element, a force, in particular a tensile and/or clamping force, acts via the retention element on a wall, for example, the wall already mentioned above, of a pipe and the probe holder can thus be secured to this wall. As a result of the cooperation of the arresting element and access element, a force is produced, wherein in particular as a result of a or the above-mentioned retention element which can be pressed against the wall and/or as a result of the arresting element, in particular as a result of at least one standing base of the arresting element which can be pressed against the wall, there is produced a force which acts on the wall, in particular on the inner side and/or the outer side of the wall.

Furthermore, the invention relates to a method for securing an, in particular, rod-like measuring instrument to an opening of a wall of a pipe, wherein an access element is arranged above the opening in such a manner that an access opening is orientated toward the opening and wherein the in particular rod-like measuring instrument is introduced and fixed in the access opening. The measuring instrument may in this instance have a rod-like probe and/or transmit a rod-like measurement beam through the access opening.

With regard to the method according to the invention, the above-mentioned object and in particular the object is to provide a method of the type mentioned, in which method there is used a probe holder of the type mentioned in the introduction and by means of which the disadvantages mentioned in the introduction when securing to an opening of a wall of a pipe are overcome.

The object of this invention can also be achieved with the method according to the invention in order to achieve the objective that the access element is securely clamped to the opening by a retention element by a position change of an arresting element, which change is preferably driven by a screw movement, in particular in an insertion direction of the access opening.

### BRIEF DESCRIPTION OF THE DRAWINGS

A plurality of embodiments of the invention are described in greater detail below with reference to the schematic drawings, in which:

FIGS. 1A-C are perspective views from different viewing angles of a first embodiment according to the invention of the probe holder according to the invention, wherein the illustration of the probe holder according to FIG. 1A is illustrated partially as a sectioned view,

FIG. 2A is a sectioned view of the embodiment according to FIGS. 1A-C, wherein an arresting element is present in a second state which releases the securing,

FIG. 2B is a sectioned view of the embodiment according to FIGS. 1A-C, wherein an arresting element is present in a first state which fixes the securing,

FIGS. 3A-C are perspective views from different viewing angles of a second embodiment according to the invention of the probe holder according to the invention, wherein the illustration of the probe holder according to FIG. 3A is illustrated partially as a sectioned view,

FIG. 4A is a sectioned view of the embodiment according to FIGS. 3A-C, wherein an arresting element is present in a second state which releases the securing,

FIG. 4B is a sectioned view of the embodiment according to FIGS. 3A-C, wherein an arresting element is present in a first state which fixes the securing,

FIGS. 5A-5B are perspective views from different viewing angles of a third embodiment according to the invention of the probe holder according to the invention, wherein the illustration of the probe holder according to FIG. 5A is illustrated partially as a sectioned view,

FIG. 6A is a sectioned view of the embodiment according to FIGS. 5A-B, wherein an arresting element is present in a second state which releases the securing,

FIG. 6B is a sectioned view of the embodiment according to FIGS. 5A-B, wherein an arresting element is present in a first state which fixes the securing,

FIGS. 7A-C are perspective views from different viewing angles of a fourth embodiment according to the invention of the probe holder according to the invention, wherein the illustration of the probe holder according to FIG. 7A is indicated partially as a sectioned view,

FIG. 8A is a sectioned view of the embodiment according to FIGS. 7A-7C, wherein an arresting element is present in a second state which releases the securing,

FIG. 8B is a sectioned view of the embodiment according to FIGS. 7A-7C, wherein an arresting element is present according to a first configuration for securing in a first state which fixes the securing, and

FIG. 8C is a sectioned view of the embodiment according to FIGS. 7A-7C, wherein an arresting element is present according to a second configuration for securing in a first state which fixes the securing.

### DETAILED DESCRIPTION OF THE PREFERRED EMBODIMENTS

The invention is explained below with reference to examples in which the probe holder is retained on a pipe opening of a pipe wall. In other embodiments, the probe holder is retained on an opening which is formed in a wall which does not belong to a pipe.

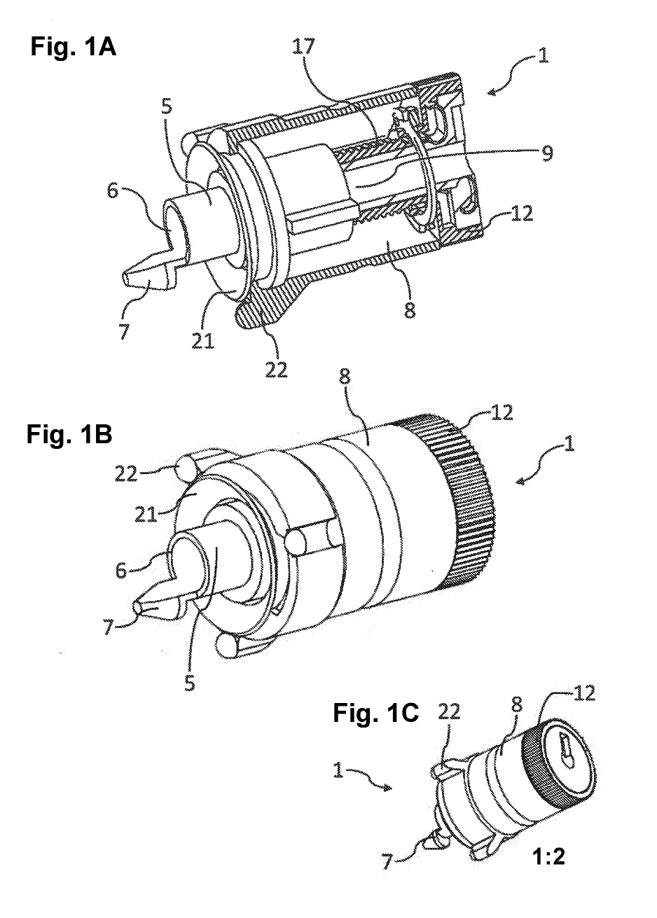

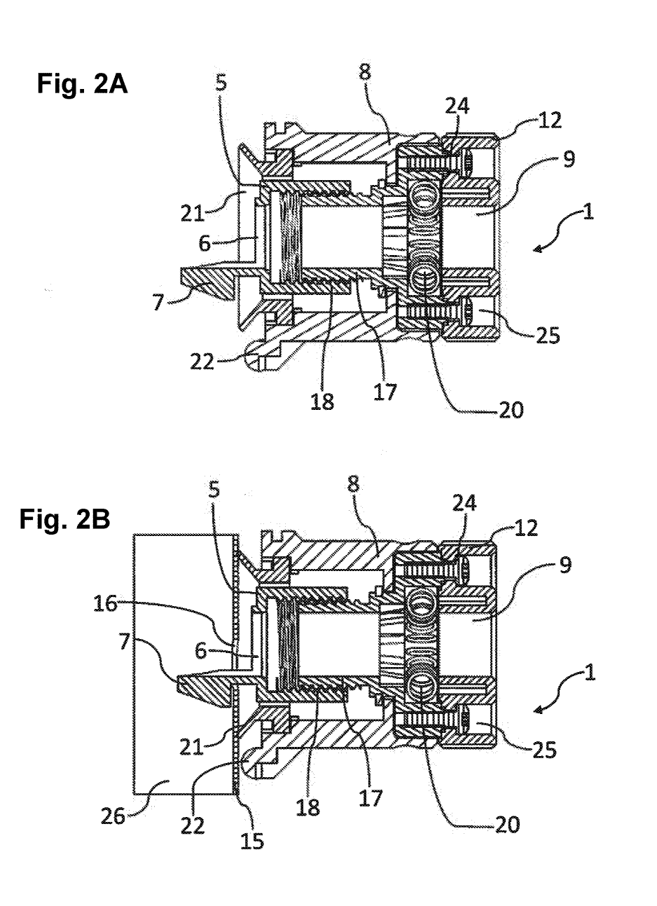

FIGS. 1A-1C and 2A-2B show a first specific embodiment of the probe holder according to the invention, which embodiment is generally designated 1.

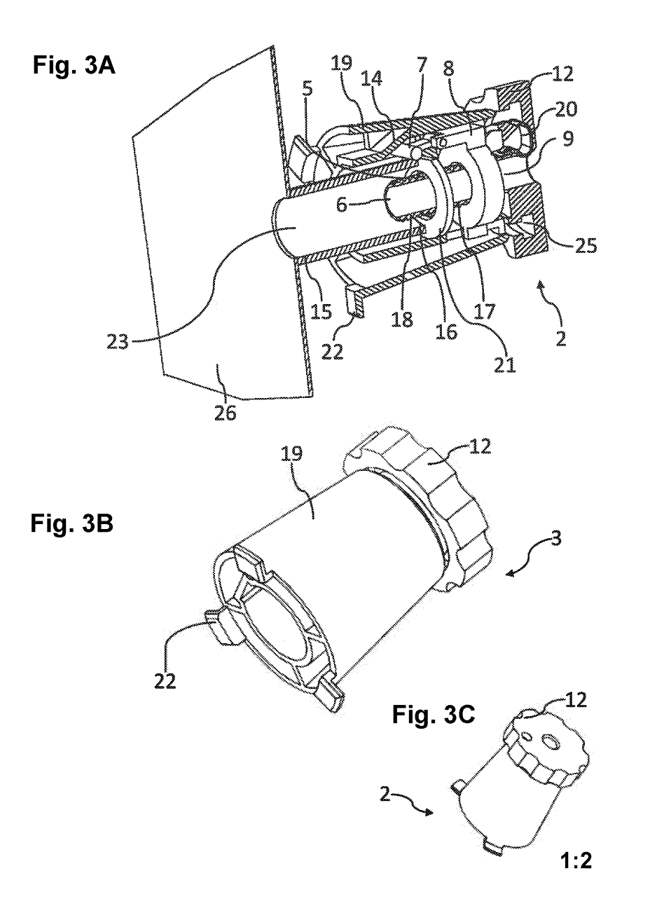

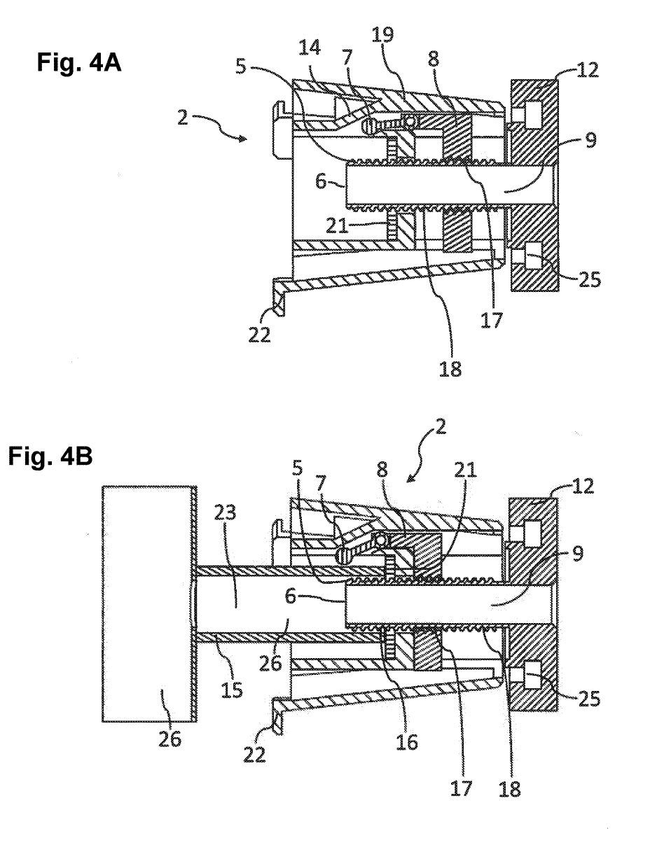

FIGS. 3A-3C and 4A-4B show a second specific embodiment of the probe holder according to the invention, which embodiment is generally designated 2.

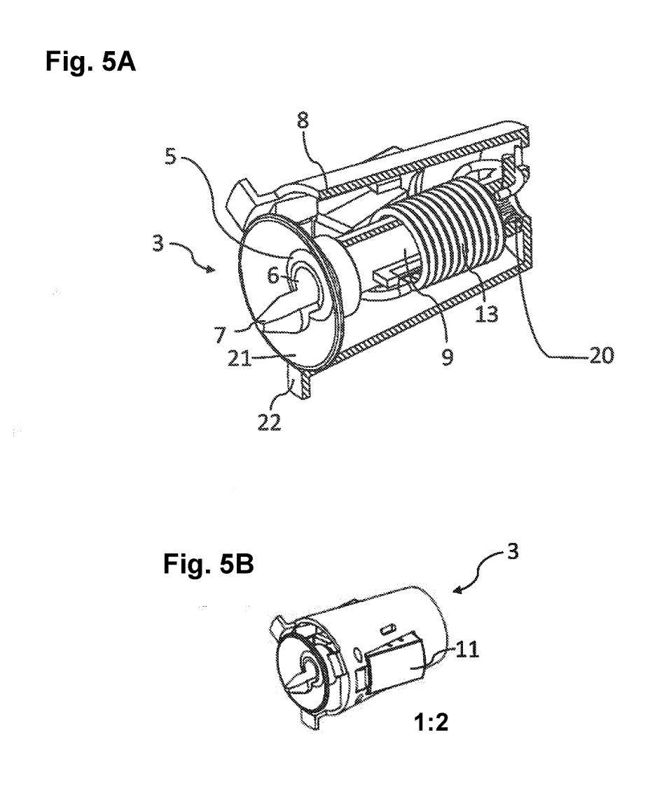

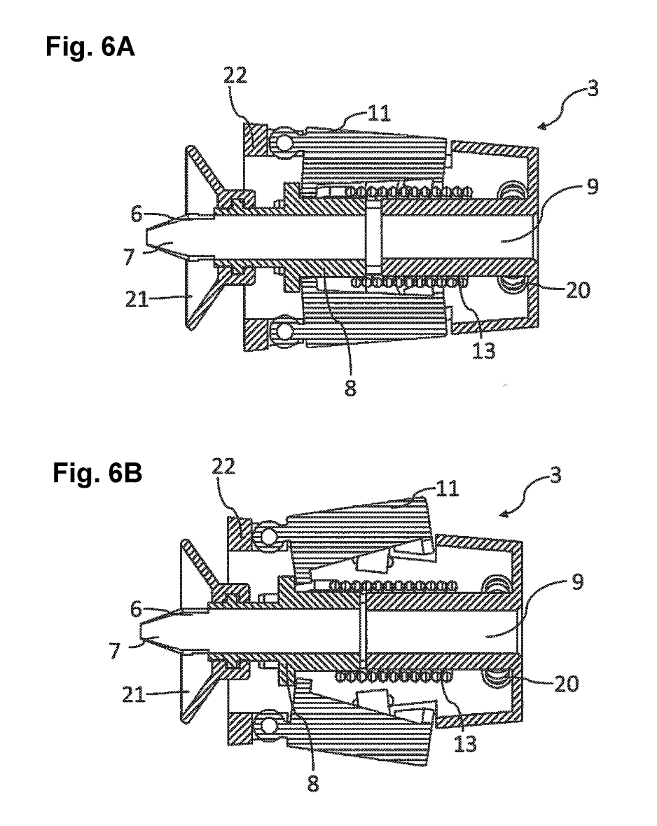

FIGS. 5A-5B and 6A-6B show a third specific embodiment of the probe holder according to the invention, which embodiment is generally designated 3.

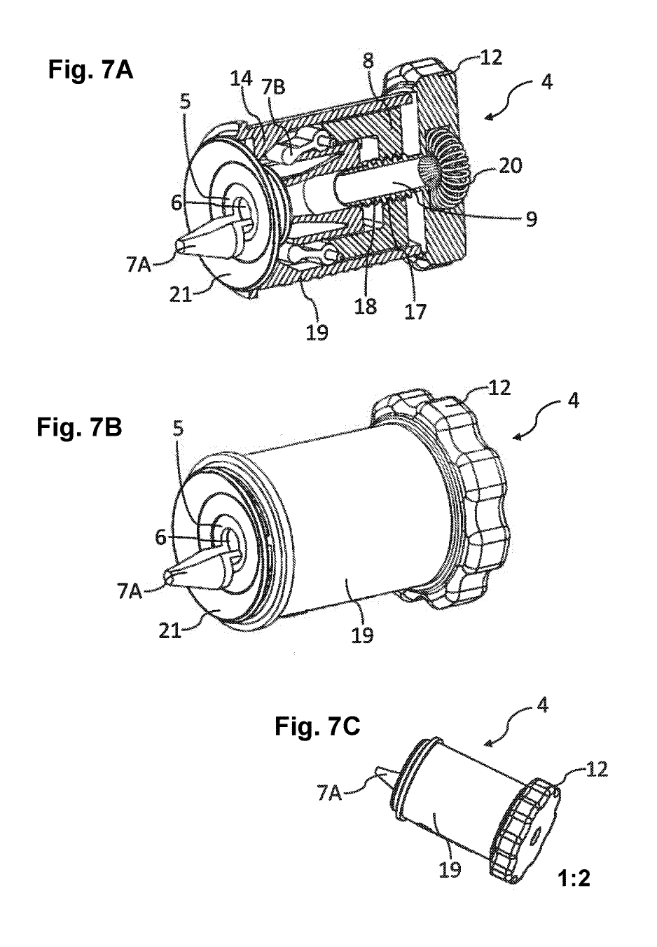

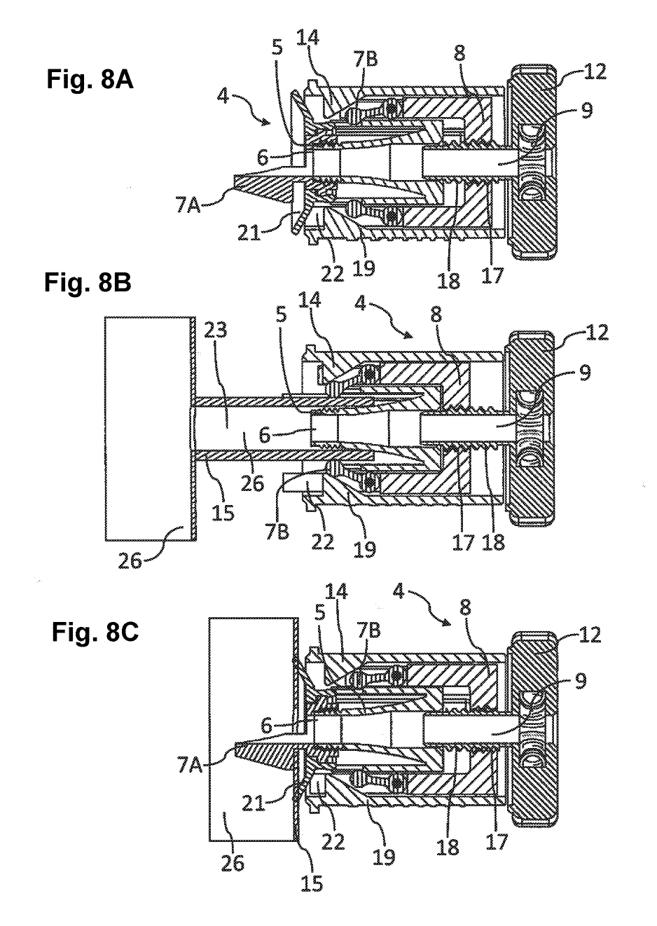

FIGS. 7A-7C and 8A-8C show a fourth specific embodiment of the probe holder according to the invention, which embodiment is generally designated 4.

The probe holders 1, 2, 3, 4 according to the invention all have an access element 5 which can be fitted to an opening in a wall of a pipe and which has at least one portion of a continuous access opening 6. The access opening 6 serves to receive and insert an in particular rod-like measuring instrument (not illustrated). There is therefore provision for the measuring instrument to be inserted through the access opening 6 and to be able to be introduced into an opening in a wall of a pipe along an access channel 9 so that at least a portion of the measuring instrument protrudes through the opening into the inner side of the pipe. Alternatively, it is possible to use a measuring instrument which sends a measuring beam through the access opening 6 into the pipe 26.

In order to secure the probe holder 1, 2, 3, 4 according to the invention to a wall 15 of a pipe 26, in an embodiment according to one of FIGS. 1A-1C to 8A-8C, there is provision for an arresting element 8 to be arranged so as to be able to be moved relative to the access element 5 in an insertion direction of the access opening 6 between a first position and a second position. There is further provision for the arresting element 8 to cooperate with the access element 5, in particular with a retention element 7, 7A, 7B which is constructed to secure the probe holder 1, 2, 3, 4 to a or the mentioned wall 15 of a pipe 26 in such a manner that, in the first position of the arresting element 8, a state which fixes the securing is defined and in the second position a state which releases the securing is defined. If the probe holder 1, 2, 3, 4 according to the invention is thus fitted to a wall 15 in the position for use and if the arresting element 8 is located in the first position, as shown in FIGS. 2B, 4B, 6B, 7B and 7C, the probe holder 1, 2, 3, 4 according to the invention is fixedly secured to the wall 15 by means of cooperation of the retention element 7, 7A, 7B and the arresting element 8. In this instance, the retention element 7 (optionally with additional retention elements which are not illustrated) carries out a clamping movement which involves, for example, in FIGS. 4A-4B, 5A-5B and 7A-7C a narrowing of a clear inner diameter, by which narrowing the probe holder 1 can be fixed to a pipe nozzle 23. In other embodiments, this clamping movement is achieved by an expansion in a pipe nozzle 23 or behind a pipe opening 16.

If the arresting element 8, as shown in FIGS. 2A, 4A, 6A and 8A, is moved into the second position, the securing is released so that the probe holder 1, 2, 3, 4 according to the invention can be removed from the wall 15.

The access element 5 forms, as shown in FIGS. 1A, 2A, 2B, 3A, 4A, 4B, 5A, 6A, 6B, 7A and 8A-C, at least a portion of an access channel 9 for receiving an in particular rod-like measuring instrument. The arresting element 8 is arranged outside the access channel 9.

In order to be able to move the arresting element 8 from the first position into the second position or from the second position into the first position, the probe holder 1, 2, 3, 4 has a manually operable handle 10, 11, 12. By actuating the handle 10, 11, 12, the arresting element 8 can preferably be moved in a stepless manner between the first and the second position by translational transposition.

In the embodiment of the probe holder 3 according to the invention illustrated in FIGS. 5A-5B and 6, the handle 10 is constructed as an actuation lever 11 which can be actuated laterally with respect to the insertion direction, in particular with respect to the extent direction of the access channel 9. In FIG. 6B, it is illustrated how the arresting element 8 of the probe holder 3 according to the invention is present in the first position so that the probe holder 3 according to the invention is secured in the position for use to the wall 15 of a pipe 26 and the securing is fixed. In this instance, the two wings of the actuation lever 11 expand outward in a radial direction with respect to the longitudinal axis of the access channel 9. As a result of the cooperation of the retention element 7 and the arresting element 8, in particular the standing bases 22 of the arresting element 8, a clamping force acts on the wall 15, in particular on the outer side of the wall 15, by which the probe holder is fixedly secured. The restoring element 13 which in this specific embodiment is constructed as a restoring spring, pulls the arresting element 8 into the first or fixing position in this case when the actuation lever 11 is not actuated, wherein the spacing between the arresting element 8 and access element 5 and the spacing between the arresting element 8 and retention element 7 in the first position, as shown in FIG. 6B, is smaller than the spacing in the second position, as shown in FIG. 6A. In order to move the arresting element 8 into the second position and to release the securing, it is possible to move the actuation lever 11 with respect to the extension direction of the access channel 9 in a radial direction toward the access channel 9 by the actuation lever 11 being able to be actuated, for example, using only one hand, in particular by being pressed together. In this instance, the spacing between the arresting element 8 and access element 5 or between the arresting element 8 and retention element 7 increases so that between the retention element 7 and the standing bases 22 no further clamping force which acts on the wall 15 of a pipe 26 is produced.

In the embodiments of the probe holder 1, 2, 4 according to the invention as illustrated in FIGS. 1A-1C, 2A-2B, 3A-3C, 4A-4B, 7A-7C and 8A-8C, the handle 10 is constructed as a rotatable actuation screw 12. The actuation screw 12 is in this instance rotatably arranged about the longitudinal axis of the access channel 9, wherein it has a screw guide 25 in which a screw 24 is guided. By rotating the actuation screw 12, the arresting element 8 can be moved in a stepless manner between a first position, as illustrated in FIGS. 2B, 4B, 8B and 8C, in which the probe holder 1, 2, 4 according to the invention is present on the wall 15 of a pipe 26 in the fixed secured state, and a second position, as illustrated in FIGS. 2A, 4A and 8A, in which the probe holder 1, 2, 4 according to the invention is present in a state which releases the securing.

The arresting element 8 of the embodiments of the probe holder 1, 2 and 4 according to the invention has a thread 17, in particular an inner thread (cf. the probe holder 1 and 4 according to the invention) or an outer thread (cf. the probe holder 3 according to the invention) which is screwed or can be screwed into a corresponding counter-thread 18, in particular an outer thread or an inner thread, wherein, by actuating the actuation screw 12, the thread 17 of the arresting element 8 can be screwed into or screwed out of the counter-thread 18. The arresting element 8 moves by the rotation of the actuation screw 12 in an axial direction along the longitudinal axis of the access channel 9 and converts the rotational movement of the actuation screw 12 into a translational movement in this instance. If the arresting element 8 is in a first position, the probe holder 1, 2, 4 according to the invention is fixedly secured to the wall 15 of a pipe 26 in the position for use. In this instance, the spacing between the arresting element 8 and the access element 5 is smaller than if the arresting element 8 had been moved relative to the access element 5 in an axial direction along the access channel 9 into a second position, in which the spacing between the arresting element 8 and the access element 5 is greater.

The probe holder 1, 3 and 4 according to the invention has a retention element 7, 7A which is constructed as a hook for introducing into an or the opening 16 and which engages behind the opening 16 and can be placed with a face which faces the wall on the inner side of the wall 15. The retention element 7, 7A is constructed in such a manner that it is connected to the access element 5 and can be removed from the access element 5. FIG. 8B shows the probe holder 4 with the retention element 7A removed. This enables the retention element 7, 7A to be replaced as necessary. The arresting element 8 comprises three standing bases 22 which are arranged so as to be laterally offset with respect to the access opening 6 and which can be fitted to the outer side of the wall 15. By rotating the actuation screw 12, the spacing between the standing bases 22 of the arresting element 8 and the hook on the access element 5 can be reduced in a stepless manner so that the cooperation produces a force, in particular, a clamping and/or tensile force which in particular acts on the inner side of the wall as a result of the hook and on the outer side of the wall 15 as a result of the standing bases 22 and which fixedly secures the probe holder 1 and 4 according to the invention to the wall 15.

The probe holder 2, 4 according to the invention is constructed for externally securing to a pipe nozzle 23. In this case, the retention element 7, 7B is constructed in such a manner that the retention element 7, 7B can be pressed in particular in a radial direction with respect to the longitudinal axis of the access channel 9 against a wall 15 of a pipe 26. The retention element 7, 7B acts on a face 14 which is constructed in an oblique manner, preferably a face 14 which is constructed in an oblique manner on the inner side of a housing 19, and relative to which it is movably arranged. In the event of a relative movement in the direction toward the oblique face 14, it is redirected by the oblique face in the direction toward the wall 15 so that it defines in the first position a smaller inner diameter than in the second position. In the illustrated embodiments of the probe holder 2, 4 according to the invention, the arresting element 8 is connected in an articulated manner about a pivot location to the retention element 7, 7B, in particular in a radial direction with respect to the longitudinal axis of the access channel 9, wherein the retention element 7, 7B can be moved by moving the arresting element 8 together therewith along the longitudinal axis of the access channel 9.

The embodiment of the probe holder 4 according to the invention comprises a plurality of retention elements 7A, 7B. This has the advantage that the probe holder 4 according to the invention is constructed in such a manner that it can be used universally in order to be able to fix it, for example, directly to a wall 15 of a pipe 26 or to a pipe nozzle 23.

In order to be able to fix the in particular rod-like measuring instrument inside the access channel 9 of the probe holder 1, 2, 3, 4 according to the invention, it has a clamping element 20 for axial fixing. The clamping element 20 may be constructed as a welded resilient ring, leaf spring, resilient basket-like member or the like in order to fix the measuring instrument in the desired position thereof inside the access channel. In FIGS. 1A-1C, 2A-2B, 5A-5B, 6A-6B, 7A-7C and 8A-8C, the clamping element 20 is constructed as a resilient ring. In FIG. 3A, the clamping element 20 is formed as a leaf spring.

So that no fluid, in particular no liquid and/or gas, is discharged from the inner side of the pipe through the opening 16 of the wall 15 whilst the probe holder 1, 2, 3, 4 according to the invention is securely fixed to the pipe 23 in the position for use (in which the arresting element 8 is in the first position), the probe holder 1, 2, 3, 4 according to the invention has a sealing element 21. Preferably, the sealing element 21 is constructed in an annular manner and/or in the form of the opening 16 at a distal end (with respect to a user) of the supply opening 6, in particular at a distal end of a or the supply channel 9. The sealing element 21 serves to seal a gap between the opening 16 and the access element 5. It is arranged at the outer side of the access element 5, in particular in extension of the access channel 9.

The sealing element 21 of the probe holder 1, 3, 4 according to the invention is preferably constructed as a sleeve or sealing lip of an in particular resilient material, preferably from an elastomer material. There may be provision for the sealing element 21 to be constructed in a conical and/or frustoconical manner.

The sealing element 21 of the probe holder 2 according to the invention is constructed as a sealing ring which is arranged at the outer side of the access channel 9. The sealing ring acts in the position for use of the probe holder 2 according to the invention on an end face of the pipe nozzle 23 and seals a gap between the opening 16 and the access element 5. The sealing ring may be produced from a resilient material, in particular from an elastomer material.

The probe holder 1, 2, 3, 4 according to the invention is configured in such a manner that, as a result of the relative movement of the arresting element 8 in the direction toward the access element 5, a force, in particular a tensile and/or clamping force, acts at least via the retention element 7, 7A, 7B on a or the wall 15 of a pipe 26 and fixedly secures the probe holder 1, 2, 3, 4 to a or the wall 15. As a result of the structure according to the invention, it is possible to fixedly secure the probe holder 1, 2, 3, 4 to the opening 16 on the pipe 23 in a rapid and simple manner. Furthermore, it has in comparison with previously known solutions a very high level of fixing stability so that disruptions of the measurements which are carried out by the measuring instrument can be prevented.

### LIST REFERENCE NUMERALS

1 Probe holder

2 Probe holder

3 Probe holder

4 Probe holder

5 Access element

6 Access opening

7 Retention element

8 Arresting element

9 Access channel

10 Handle

11 Actuation lever

12 Actuation screw

13 Restoring element

14 Oblique face

15 (Pipe) wall

16 (Pipe) opening

17 Thread

18 Counter-thread

19 Housing

20 Clamping element

21 Sealing element

22 Standing base

23 Pipe nozzle

24 Screw

25 Screw guide

26 Pipe

1. A probe holder (1, 2, 3, 4) comprising
an access element (5) which is fittable to an opening (16) in a wall (15), the access element (5) including at least a portion of a continuous access opening (6) constructed for inserting a measuring instrument into the opening (16),
a retention element (7, 7A, 7B) that secures the probe holder (1, 2, 3, 4) to the wall (15) of a pipe (26),
an arresting element (8) arranged to be movable relative to the access element (5) between a first position and a second position, the arresting element (8) cooperates with the retention element (7, 7A, 7B) such that in the first position a state which fixes a securing is defined, and in the second position a state which releases the securing is defined.

2. The probe holder (1, 2, 3, 4) as claimed in claim 1, wherein the probe holder (1, 2, 3, 4) forms at least a portion of an access channel (9) for receiving a measuring instrument, and the arresting element (8) is arranged outside the access channel (9).

3. The probe holder (1, 2, 3, 4) as claimed in claim 1, wherein the arresting element (8) is arranged to be movable relative to the access element (5) in an insertion direction of the access opening (6) between the first position and the second position, and the access element (5) is constructed for fitting to the opening (16) in the wall (15) of the pipe (26).

4. The probe holder (1, 2, 3, 4) as claimed in claim 1, wherein a clamping movement is carried out by at least one of an expansion or a narrowing of the retention element (7, 7A, 7B), by a movement of the arresting element (8), or a combination thereof.

5. The probe holder (1, 2, 3, 4) as claimed in claim 1, wherein the probe holder (1, 2, 3, 4) has an actuatable handle (10, 11, 12), which is actuated laterally with respect to an insertion direction, or an actuation screw (12) which is rotatably arranged about a longitudinal axis of the insertion direction, and which is constructed for stepless movement of the arresting element (8) from the first position into the second position.

6. The probe holder (1, 2, 3, 4) as claimed in claim 1, wherein the retention element (7, 7A,7B) is constructed for introduction into the opening (16) and engaging behind the opening (16).

7. The probe holder (1, 2, 3, 4) as claimed in claim 1, wherein the retention element (7, 7A, 7B) is constructed to secure the probe holder (1, 2, 3, 4) to a pipe nozzle (23) at an outer side, and the retention element (7, 7A, 7B) is pressable in a radial direction with respect to a longitudinal axis of the insertion direction against the wall (15) of the pipe (26), such that the retention element (7, 7A, 7B) acts on a face (14) which is constructed in an oblique manner on an inner side of a housing (19), and relative to which it is movably arranged, together with the arresting element (8) such that for a relative movement in a direction toward the oblique face (14), it is redirected by the oblique face in a direction of the wall (15) or defines in the first position a smaller inner diameter than in the second position.

8. The probe holder (1, 2, 3, 4) as claimed in claim 1, wherein the probe holder (1, 2, 3, 4) has a plurality of retention elements (7, 7A, 7B), which are constructed differently.

9. The probe holder (1, 2, 3, 4) as claimed in claim 1, wherein the arresting element (8) is arranged to be movable relative to the access element (5) by a thread (17) and a corresponding counter-thread (18).

10. The probe holder (1, 2, 3, 4) as claimed in claim 1, wherein the access element (5) and the retention element (7, 7A, 7B) are connected to each other such that the retention element (7, 7A, 7B) is removable from the access element (5).

11. The probe holder (1, 2, 3, 4) as claimed in claim 1, further comprising a clamping element (20) at a proximal end of the access opening (6), for axially fixing a measuring instrument which is inserted into the access opening (6).

12. The probe holder (1, 2, 3, 4) as claimed in claim 1, further comprising an annular sealing element (21) arranged on the access opening (6) or at an outer side of the access element (5) for sealing a gap between the opening (16) and the access element (5),

13. The probe holder (1, 2, 3, 4) as claimed in claim 1, wherein the probe holder (1, 2, 3 4) is configured such that, as a result of the relative movement of the arresting element (8) in a direction toward the access element (5), a force acts via at least one of the retention element (7, 7A, 7B) or the arresting element (8) on the wall (15) of a pipe (26) and fixedly secures the probe holder (1, 2, 3, 4) to the wall (15).

14. A method for securing a measuring instrument to an opening (16) of a wall (15) of a pipe (26), comprising arranging an access element (5) above the opening (16) such that an access opening (6) is orientated toward the opening (16), and introducing and fixing the measuring instrument in the access opening (6), clamping the access element (5) to the opening (16) by a position change of an arresting element (8) in an insertion direction of the access opening (6) by a retention element (7, 7A, 7B).

15. The method as claimed in claim 14, further comprising using a probe holder (1, 2, 3, 4) including the access element (5) which is fittable to the opening (16) in the wall (15), the access element (5) including at least a portion of the access opening (6) that is constructed for inserting a measuring instrument into the opening (16), the retention element (7, 7A, 7B) that secures the probe holder (1, 2, 3, 4) to the wall (15) of a pipe (26), and the arresting element (8) arranged to be movable relative to the access element (5) between a first position and a second position, the arresting element (8) cooperating with the retention element (7, 7A, 7B) such that in the first position a state which fixes a securing is defined, and in the second position a state which releases the securing is defined.

16. The probe holder (1, 2, 3, 4) as claimed in claim 1, wherein the arresting element (8) is movable counter to a restoring force of a restoring element (13) from the first position into the second position.

17. The probe holder (1, 2, 3, 4) as claimed in claim 6, wherein the retention element (7, 7A, 7B) has a hook which is arranged in an extension of a longitudinal axis of the insertion direction.

18. The probe holder (1, 2, 3, 4) as claimed in claim 1, wherein the arresting element (8) or a housing (19) has at least one standing base (22) which is arranged in laterally offset with respect to the access opening (6).

19. The probe holder (1, 2, 3, 4) as claimed in claim 1, wherein the retention element (7, 7A, 7B) and the arresting element (8) define between them a variable spacing.
